(19) United States
(12) Patent Application Publication
(10) Pub. No.: US 2007/0215429 A1
(43) Pub. Date: Sep. 20, 2007

(54) THRUST MEMBER FOR SYNCHRONIZING DEVICES

(76) Inventor: Jorg Schwarzbich, Bielefeld (DE)

Correspondence Address: RICHARD M. GOLDBERG, 25 EAST SALEM STREET, SUITE 419, HACKENSACK, NJ, 07601, US

(21) Appl. No.: 11/674,634

(22) Filed: Feb. 13, 2007

(30) Foreign Application Priority Data
Mar. 14, 2006 (DE) 20 2006 004 181.8

(51) Int. Cl. F16D 23/06

(52) U.S. Cl. 192/53.341; 74/339

(57) ABSTRACT

A synchronizing device in gear shift transmissions has a gear (28), a shift sleeve (30) which is displaceably engaged with the gear (28) by internal teeth (32), and thrust members (10) disposed between the gear (28) and the shift sleeve (30), each of the thrust members having a casing (12) accommodated in an axial groove (40) of the gear (28), and a spring (18) biasing a pressure member (14) against the internal teeth (32) of the shift sleeve (30). The thrust member (10) is shaped as a flat parallelepiped, and the spring (18) extends transversely of the biasing direction and is supported on the casing (12) or the gear (28) with its peripheral portion and supports the pressure member (14) with is central portion.

The invention relates to a thrust member for synchronizing devices in gear shift transmissions having a gear, a shift sleeve which is displaceably engaged with the gear by internal teeth, and thrust members disposed between the gear and the shift sleeve, each of said thrust members having a casing accommodated in an axial groove of the gear, and a spring biasing a pressure member against the internal teeth of the shift sleeve.

Synchronizing systems serve in manual transmissions for producing a synchronism between two gears mounted on a common shaft before a driving connection is produced between these gears. For this purpose, a synchronizing ring is provided between the drive gear that is rigidly mounted on the shaft and the driven gear mounted for rotation on the shaft, and the synchronizing ring can be urged into frictional engagement with the driven gear. When the shift sleeve on the driving gear is shifted toward the driven gear, its internal teeth run first against beveled teeth of the synchronizing ring, so that a frictional face of the synchronizing ring is urged against the driven gear. As long as the rotary speeds of the driving and driven gears are not the same, the torque exerted by the friction produced by the contact with the synchronizing ring prevents any further displacement of the shift sleeve. Only when the rotary speeds are equal can the synchronizing ring rotate relative to the shift sleeve to a position wherein the shift sleeve can be shifted against external teeth on the driven gear, so that the driven gear is coupled torsionally to the driving gear. The thrust members arranged between the driving gear and the shift sleeve eliminate the free play between the driving gear and the shift sleeve and thus contribute to the reduction of noise and wear.

A synchronizing device having thrust members of the type indicated above has been described in EP 1 400 717 A1. The casing of the thrust member has a cup-shaped configuration and accommodates a helical spring as well as a ball that forms the pressure member. The casing is tiltably supported on the bottom of the groove of the gear, so that the ball which engages into a locking recess of the shift sleeve may follow the axial movement of the shift sleeve within certain limits.

In DE 195 80 558 C1 a synchronizing system is described, in which the axial grooves serving to accommodate the thrust members have a T-shaped profile. The casings of the thrust members have a shape complementary to this profile and are supported on the shoulders of the T-shaped groove near the end that is provided with the pressure member. Thus the thrust members are guided for displacement in the grooves. The pressure members are biased by the springs into recesses in the internal teeth of the drive gear. When the shift sleeve is shifted, the entire thrust members are first carried a short distance until they abut against the synchronizing ring. Only then are the pressure members forced back against the force of the spring, so that the shift sleeve can be shifted further by overcoming a slight detent resistance. The manufacture of T-shaped grooves, however, is relatively expensive. Moreover, a relatively great amount of space is required to accommodate the thrust members, and due to the grooves widened at the radially outer ends the external teeth of the gear are interrupted on a relatively great circumferential length. Furthermore, as the thrust members shift, friction and wear occur because the casings are supported in the T-shaped grooves only with their shoulders on a relatively small surface.

It is therefore the object of the invention to create a thrust member that can be manufactured and mounted more easily and will permit a compact construction of the synchronizing system and an easy movement of the shift sleeve.

According to the invention, this object is achieved by the fact that the casing of the thrust member is shaped as a parallelepiped, and the spring extends transversely of the biasing direction and is supported on the casing or the gear with its peripheral edge and supports the pressure member with its central portion.

The spring, e.g. a leaf spring, a cup spring, a stack of leaf or cup springs or a rod spring, extends in the tangential plane of the gear, i. e. the plane normal to the radial direction into which the pressure member is biased. Thanks to this, it is possible to obtain a very flat shape of the parallelepipedal casing and, accordingly, also the axial groove in the gear, so that a compact construction becomes possible. The spring is supported on the casing or on the gear with its peripheral portion while being held in the groove of the gear in such a manner that a sufficient spring travel is provided for its central portion. When the spring is supported with its peripheral portion directly on the gear, the support surface may be relatively large, so that only little wear will occur during the axial movement of the thrust member. When the peripheral portion of the spring is supported on the casing, the thrust member may in turn be supported on the gear with its entire bottom surface, so that the wear will also be minimized. Thanks to its relatively large footprint, the spring can easily be snap-fastened in the casing. Since the gear needs to have only shallow grooves for the relatively flat casings of the thrust members, the effect of weakening the gear is reduced.

Advantageous embodiments of the invention are described in the sub-claims.

The casing of the thrust member is preferably made of plastic and forms, at the end which receives the pressure member such as detent ball, an abutment which secures the ball against escape.

When the spring is supported directly on the bottom of the groove of the gear, the bottom of this groove is preferably recessed in its central portion in order to provide for a sufficient spring travel. The casing may encircle the edge of the spring in such a manner that the spring will follow the axial movement of the pressure member and the casing when the shift sleeve is displaced. As an alternative, it is also possible, however, that the spring is retained stationary in the groove of the gear, so that the detent ball may roll on the spring like the ball of a ball-bearing when the shift sleeve is displaced.

When, on the other hand, the spring is snap-fastened in the casing, so that it is supported on the casing with its peripheral edge, the casing, the spring and the pressure member form a pre-manufactured unit that can easily be mounted.

Preferably, a radially outer surface of the casing is formed with projections that engage into the gaps between the internal teeth of the shift sleeve. In this case, even when the spring breaks or the pressure member is missing or jammed, the shift sleeve can still be supported by the projections of the casing, so that even in this case any chattering between the shift sleeve and the gear can be prevented.

Embodiments of the invention are described hereinafter with the aid of the drawing, in which

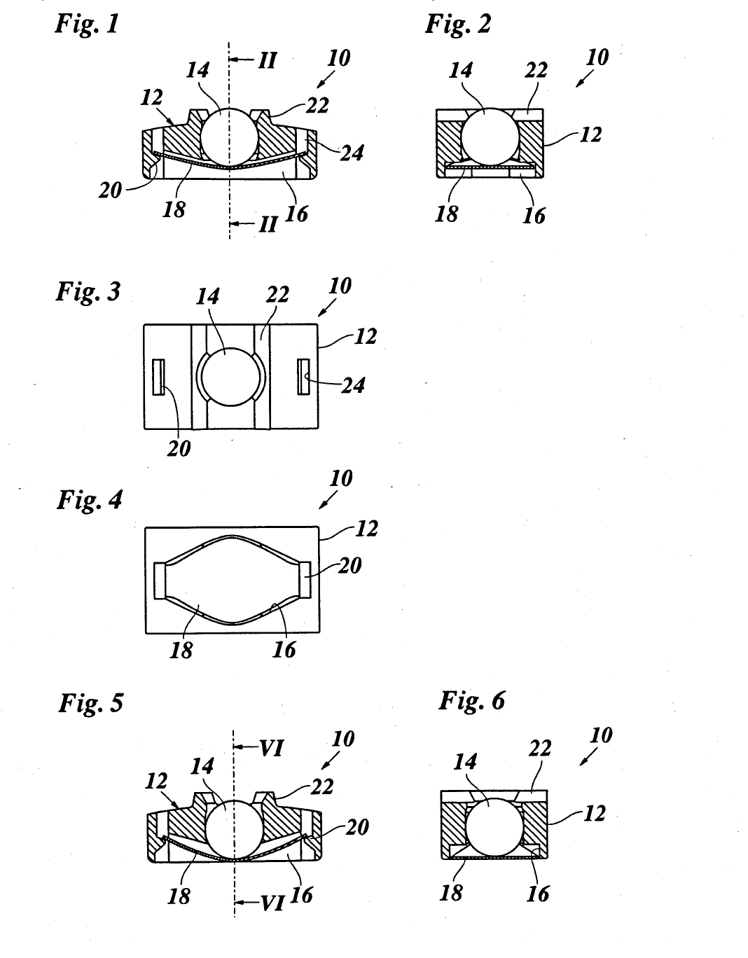

FIG. 1 shows an axial section of a thrust member according to an embodiment of the invention;

FIG. 2 shows a section taken along the line II-II in FIG. 1;

FIG. 3 shows the thrust member of FIG. 1 in a plan view;

FIG. 4 shows a bottom view of the thrust member of FIG. 1;

FIG. 5 shows a sectional view of the thrust member in an elastically deformed state;

FIG. 6 shows a section taken along the line VI-VI in FIG. 5;

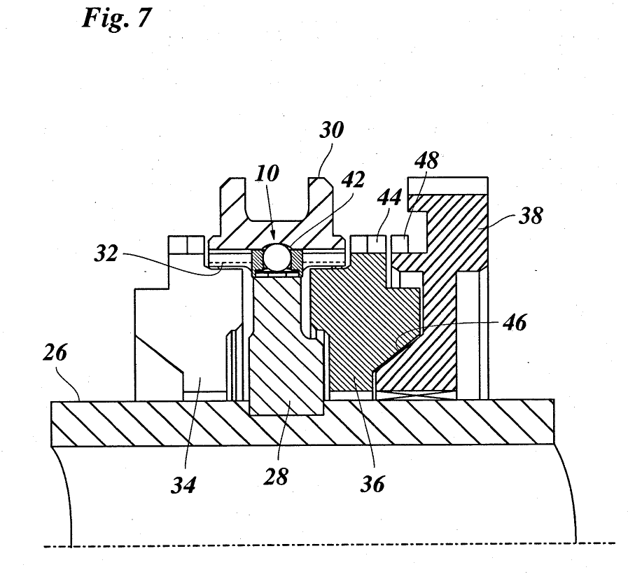

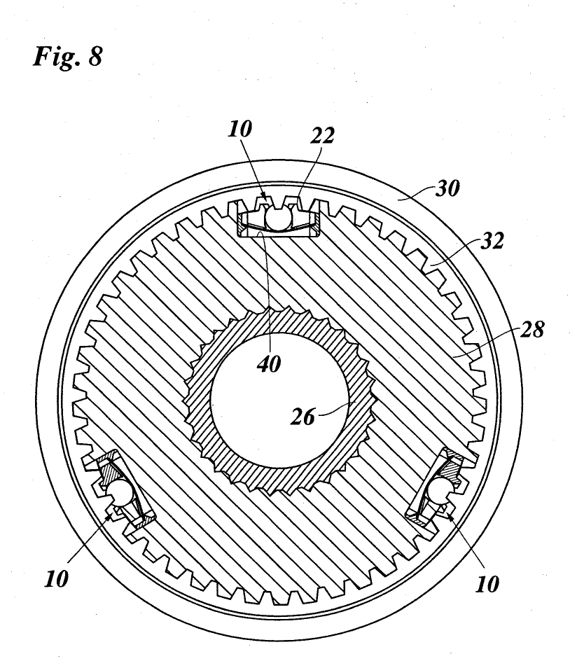

FIG. 7 shows an axial section of one half of a synchronizing device with a built-in thrust member; and

FIG. 8 shows a cross-section of the synchronizing device at the position of the thrust members.

The thrust member shown in FIG. 1 comprises a flat, parallelepipedal plastic casing 12 which has a slightly bulged surface and is thereby adapted to the curvature of an internal gearing of a shift sleeve of a synchronizing device that has not been shown in FIG. 1. In its central portion, the casing 12 forms a chamber that extends radially in relation to the synchronizing device and accommodates a pressure member 14 that is shaped as a detent ball. At the top end in FIG. 1, the chamber is narrowed to such an extent that the movement of the pressure member is limited. At the bottom end, the chamber is also narrowed, but in such a manner that the detent ball may be snapped-in from below.

On the bottom side, the casing 12 forms a shallow recess 16 which extends almost over the entire footprint of the casing. This recess accommodates a leaf spring 18 that extends at right angles to the axis of the chamber and, in the condition shown in FIG. 1, biases the pressure member 14 against its top abutment. The leaf spring 18 has its opposite ends supported on ribs 20 that project from the peripheral wall of the casing 12 into the recess 16. When the thrust member 10 is assembled, the pressure member 14 may first be pressed into the chamber of the casing 12 from below, and then the leaf spring 18 may be snapped-in from below, so that it is locked behind the ribs 20.

In an alternative embodiment, the assembly is simplified by forming the casing in two parts, i. e. a top part forming the chamber for the pressure member 14, and a bottom part that may for example be locked at the top part and forms a support for the spring 18 and into which the spring can easily be inserted prior to the assembly. As another alternative, the casing may be formed with a slot that opens laterally and through which the spring 18 can be inserted.

On the top side of the casing 12, a projection 22 is formed on either side of the chamber accommodating the pressure member 14, and this projection extends over the entire width of the casing 12, as is shown in FIG. 2. In its outer portions, the casing 12 is perforated by rectangular recesses 24 which serve for molding the ribs 20.

As is shown in FIG. 3, the projections 22 are slightly cut by the chamber for the pressure member 14.

FIG. 4 illustrates the lens-like shape of the footprint of the recess 16 and of the leaf spring 18.

FIGS. 5 and 6 show the thrust member in an elastically deformed condition. Here, the pressure member 14 has been pushed down in the chamber, and the leaf spring 18 is deflected to a larger extent, so that its lower apex is approximately flush with the bottom side of the casing 12. Due to the deflection, the spring is reduced in length. As is shown in FIG. 5, the surfaces of the ribs 20 that serve as supports for the spring, slant inwardly. This has the effect that the spring is also displaced downwardly in proportion to the reduction of its length. This has the advantageous result that, for a given amount of deflection of the spring, the travel distance of the pressure member 14 becomes larger. As a result, by using a relatively stiff spring, a relatively high biasing force in the position shown in FIG. 1 can be achieved while preventing that the spring force increases too much when the spring is deflected and/or the elastic limit of the spring is exceeded.

FIGS. 7 and 8 show the thrust member 10 in its mounted position in a synchronizing device of a gear shift transmission.

In FIG. 7, a shift sleeve 30 is arranged on a gear 28 that is mounted on a shaft 26 in a rotationally rigid manner. The shift sleeve has internal teeth 32 engaging into the teeth of the gear 28, and can be displaced on the gear in axial direction of the shaft 26.

Synchronizing rings 34, 36 are arranged on both sides of the gear 28, and these synchronizing rings are arranged to rotate together with the gear 28 and the shift sleeve 30, but can be rotated relative to the gear 28 within a limited angular range. On the side of the synchronizing ring 36 facing away from the gear 28, a gear 38 has been shown that is rotatably supported on the shaft 26 and can be coupled to the gear 28 in a rotationally rigid manner by means of the shift sleeve 30. Another gear (not shown) with a different diameter is arranged on the side of the other synchronizing ring 34 facing away from the gear 28. By shifting the shift sleeve 30 into one or the other direction, the shaft 26 can thus drive either the gear 38 or the other gear (not shown), so that different transmission ratios may be established in the transmission.

As can be seen in FIG. 8, the gear 28 is provided in its outer peripheral surface with three shallow grooves 40 that extend in axial direction through the entire gear, are arranged in angular intervals of 120°, and have a rectangular cross-section that is elongated in radial direction and interrupts the outer gearing of the gear 28. The thrust members 10 are inserted into the grooves 40, and, as is shown in FIG. 7, each of them has its pressure member 14 engaged in a shallow through-shaped depression 42 that is formed in one of the teeth of the shift sleeve 30.

When, in FIG. 7, the shift sleeve 30 is slightly displaced towards the right, the internal teeth 32 run onto beveled teeth portions of outer teeth 44 of the synchronizing ring 36. During this movement of the shift sleeve 30, the thrust member 10 is entrained due to the engagement of the pressure member 14 into the depression 42. In the example shown, the movement of the thrust member 10 is limited by the casing 12 abutting against the synchronizing ring 36.

Then, a conical friction surface of the synchronizing ring 36 is pushed onto an external cone 46 of the gear 38, so that the gear 38 is frictionally accelerated or decelerated to the speed of rotation of the unit formed by the gear 28, the shift sleeve 30, and the synchronizing ring 36. As long as the speeds of rotation do not yet coincide, the beveled teeth portions of the external teeth 44 of the synchronizing ring 36, which is then still subject to a high torque, provides such a resistance against the movement of the shift sleeve 30, that the internal teeth 32 cannot yet be bought into engagement with the external teeth 48 of the gear 38. Only when the speeds of rotation have become equal can the shift sleeve 30 be displaced further until it establishes a rotationally rigid connection between the gears 28 and 38. Since the pressure member 14 may no longer participate in this further displacement of the shift sleeve 30, it is pressed out of the depression 42 of the shift sleeve against the force of the spring 18. Thus, when the gear 38 is coupled to the gear 28, a detent resistance caused by the thrust members 10 has to be overcome.

The displacement of the shift sleeve 30 is controlled by a shift fork that has not been shown and that engages into a groove formed in the outer periphery of the shift sleeve.

As has been indicated in FIG. 8, the projections 22 of the thrust member 10 project so far into the gaps between the internal teeth 32 that the casing 12 of the thrust member 10 may also serve as a spacer between the gear 28 and the shift sleeve 30, independently of the pressure member 14, and may thus prevent a chatter of the teeth when the spring 18 is broken or is too weak.

What is claimed is:

1. A thrust member for synchronizing devices in gear shift transmissions of a type having a gear, a shift sleeve which is displaceably engaged with the gear by internal teeth, and thrust members disposed between the gear and the shift sleeve, each of said thrust members comprising:
a casing accommodated in an axial groove of the gear, the casing being shaped as a flat parallelepiped,
a pressure member, and
a spring biasing the pressure member against the internal teeth of the shift sleeve, and the spring extending transversely of a biasing direction thereof and being supported on one of the casing and the gear with a peripheral portion thereof and supporting the pressure member with a central portion thereof.

2. The thrust member of claim 1, wherein the pressure member is a detent body which engages a depression in the internal teeth of the shift sleeve.

3. The thrust member of claim 1, wherein the casing of the thrust member is a body molded from plastic.

4. The thrust member of claim 1, wherein the spring is supported on the casing, and the pressure member is captively held in the casing.

5. The thrust member of claim 1, wherein the casing includes a rounded external surface.

6. The thrust member of claim 1, wherein the casing has a radial outer surface formed with projections which project into gaps of the internal teeth of the shift sleeve.

7. The thrust member of claim 1, wherein the spring is a leaf spring.

8. The thrust member of claim 1, wherein the spring is accommodated in a recess of the casing and is retained by ribs projecting from walls of the casing into the recess.

9. The thrust member of claim 8, wherein the spring has a central portion extending over almost an entire width of the casing and is tapered towards ends thereof supported on the ribs.

10. The thrust member of claim 8, wherein surfaces of the ribs on which the spring is supported are slanting in a direction opposite to a direction in which the pressure member is biased.

11. A synchronizing device in a gear shift transmission, comprising:
a gear,
a shift sleeve which is displaceably engaged with the gear by internal teeth, and
thrust members disposed between the gear and the shift sleeve, each of said thrust members comprising:
a casing accommodated in an axial groove of the gear, the casing being shaped as a flat parallelepiped,
a pressure member, and
a spring biasing the pressure member against the internal teeth of the shift sleeve, and the spring extending transversely of a biasing direction thereof and being supported on one of the casing and the gear with a peripheral portion thereof and supporting the pressure member with a central portion thereof.

12. The synchronizing device of claim 11, wherein the pressure member is a detent body which engages a depression in the internal teeth of the shift sleeve.

13. The synchronizing device of claim 11, wherein the casing of the thrust member is a body molded from plastic.

14. The synchronizing device of claim 11, wherein the spring is supported on the casing, and the pressure member is captively held in the casing.

15. The synchronizing device of claim 11, wherein the casing includes a rounded external surface.

16. The synchronizing device of claim 11, wherein the casing has a radial outer surface formed with projections which project into gaps of the internal teeth of the shift sleeve.

17. The synchronizing device of claim 11, wherein the spring is a leaf spring.

18. The synchronizing device of claim 11, wherein the spring is accommodated in a recess of the casing and is retained by ribs projecting from walls of the casing into the recess.

19. The synchronizing device of claim 18, wherein the spring has a central portion extending over almost an entire width of the casing and is tapered towards ends thereof supported on the ribs.

20. The synchronizing device of claim 18, wherein surfaces of the ribs on which the spring is supported are slanting in a direction opposite to a direction in which the pressure member is biased.
